(19) United States
(12) Patent Application Publication
(10) Pub. No.: US 2026/0090622 A1
(43) Pub. Date: Apr. 2, 2026

(54) Mascara Warmer

(71) Applicant: Amber Bland, Columbus, GA (US)

(72) Inventor: Amber Bland, Columbus, GA (US)

(21) Appl. No.: 18/903,267

(22) Filed: Oct. 1, 2024

(51) Int. Cl. A45D 34/00; H05B 1/02

(52) U.S. Cl. CPC A45D 34/00; H05B 1/0297; A45D 2034/002; A45D 2200/152; A45D 2200/155

(57) ABSTRACT

A warming device includes a warming container with a flaring closed end and an open receiving end and a throat there between configured to snugly receive a tube of mascara, wherein a wall of the funnel-shaped container is waterproof and heat insulating. The device also includes a heating element in the flaring closed end powered by a power source and a heat thereof proportional to a digital thermometer. Further, a reservoir of water comprised in the flaring closed end is configured for conversion to steam based on the heating element to heat the mascara in its tube.

### SUMMARY OF THE INVENTION

A warming device includes a warming container with a flaring closed end and an open receiving end and a throat there between configured to snugly receive a tube of mascara, wherein a wall of the funnel-shaped container is waterproof and heat insulating. The device also includes a heating element in the flaring closed end powered by a power source and a heat thereof proportional to a digital thermometer. Further, a reservoir of water comprised in the flaring closed end is configured for conversion to steam based on the heating element to heat the mascara in its tube.

### BRIEF DESCRIPTION OF THE DRAWINGS

FIG. 1 is a view of the funnel-shaped mascara warmer in accordance with an embodiment of the present disclosure.

FIG. 2 is an elevational view of the boss grating to stop smaller mascara tubes and bottles in accordance with an embodiment of the present disclosure.

FIG. 3 is an elevational view of the warming container throat with grooves for steam escape in a snug fit of a mascara tube or bottle received into the warming container.

FIG. 4 is a view of a trumpet shape warming container in accordance with an embodiment of the present disclosure.

FIG. 5 is a view of a gourde-like shape warming container in accordance with an embodiment of the present disclosure.

FIG. 6 is a view of a flask-like shaped warming container in accordance with an embodiment of the present disclosure.

FIG. 7 is a view of a lighted display toggle switch used for temperature and time control of the warmer device in accordance to an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term ‘dual’ is used to refer to two different parts. In the present disclosure two separate but attached pet food dispensers having separate and adjacent food tube augers, two separate and adjacent dispenser motors and two separate dispensers.

The concept is a mascara warmer. Similar to a baby bottle warmer. You have the warmer container that you add a small amount of water in the bottom that is on a timer when started. Steams your mascara to a perfect temperature for a smooth application. The mascara warmer, also known as a mascara snug will plug in an AC wall socket with an on/off switch. Predetermined maximum in embodiments is 90°. The disclosure is small enough to travel with, like a flat iron. The mascara snug includes a plug in with an on/off switch.

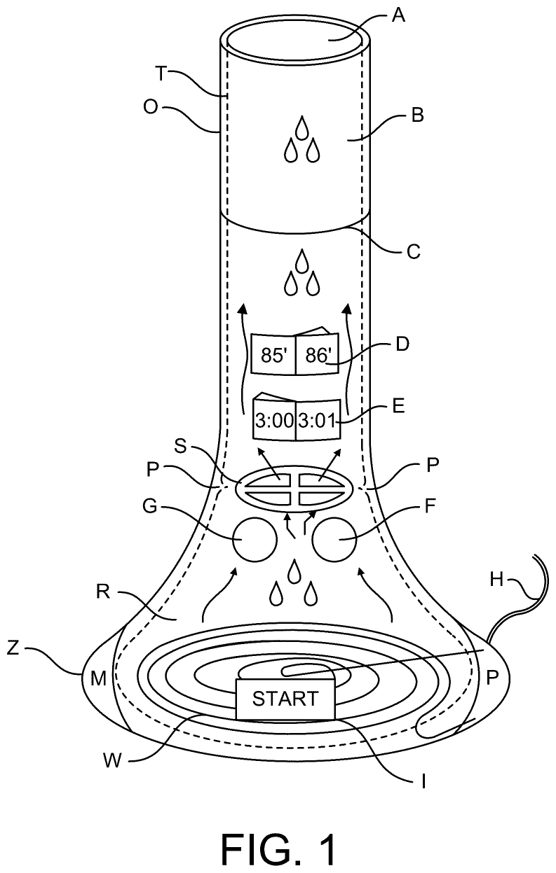

FIG. 1 is a view of the funnel-shaped mascara warmer in accordance with an embodiment of the present disclosure. The view includes the warmer opening A, the mascara warming container B, the fill water line C, the temperature button or control switch for temperature and which also display the current temperature on a face of the control switch, such as a lighted toggle switch and can toggle right for moving up a desired temperature and can toggle left for moving down a desired temperature, switch D, lighted display toggle switch E for adjusting a time period for heating the mascara tube or bottle received into the throat T of the warming container also having an outside O.

The lights G and F are for warming and ready indicators red and green respectively. The heating element W is coiled inside the flared end of the warming container and makes a complete resistive circuit with the power source P. The power cord H is compatible with domestic alternating current AC plugs to source the power supply. The boss P protruding from the inside of the throat T stops the mascara tube or bottle from falling into the water reservoir R below. The grooves Q on an inside surface of the throat T allow steam to escape the warming device. The stop S is a grating which sits on the Boss P for preventing smaller mascara tubes or bottles from falling through. The power button labeled I switches on the power source initially which is subsequently controlled by the temperature and lighted toggle switch electronics.

Squiggly headed arrows indicate a direction of a steam created in the reservoir R. Water droplets through the throat and into the reservoir are indicated by groupings of 3 water droplets falling under the force of gravity. The heating element W is a resistive wire which converts water into steam as controlled by the switch D and E. The warming container also includes a memory for presets and maximum and minimum temperatures and times of operation of the warming device according to factory and user preferences.

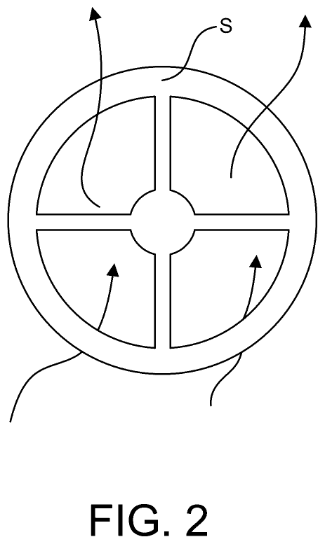

FIG. 2 is an elevational top view of the boss grating to stop smaller mascara tubes and bottles in accordance with an embodiment of the present disclosure. Squiggly headed arrows indicate passage of steam from underneath and up through the throat T.

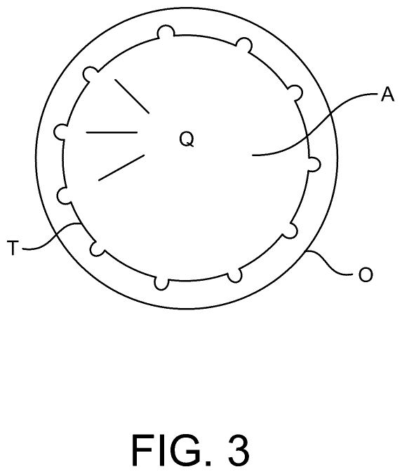

FIG. 3 is an elevational view of the warming container throat with grooves for steam escape in a snug fit of a mascara tube or bottle received into the warming container. The view shows the grooves Q in cross section of the throat T and in relation to the warmer container outside O.

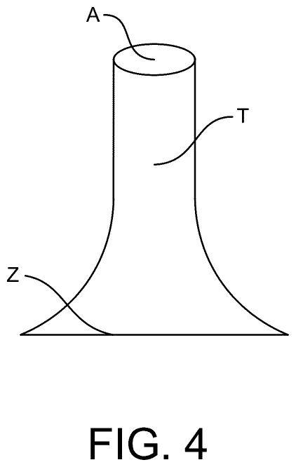

FIG. 4 is a view of a trumpet shape warming container in accordance with an embodiment of the present disclosure. The view indicates the flared closed end Z, the receiving open end A and the throat T there between.

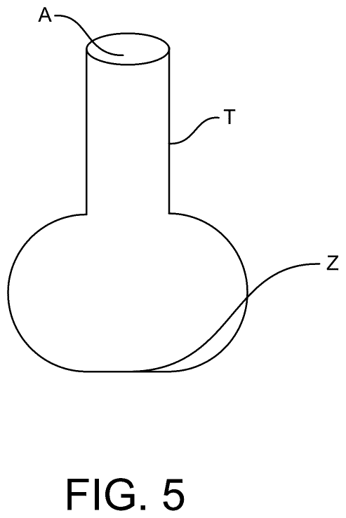

FIG. 5 is a view of a gourde-like shape warming container in accordance with an embodiment of the present disclosure. The view indicates the flared closed end Z, the receiving open end A and the throat T there between.

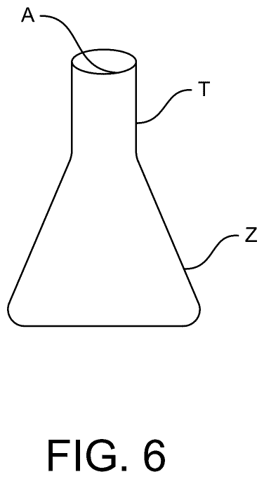

FIG. 6 is a view of a flask-like shaped warming container in accordance with an embodiment of the present disclosure. The view indicates the flared closed end Z, the open receiving end A and the throat T there between.

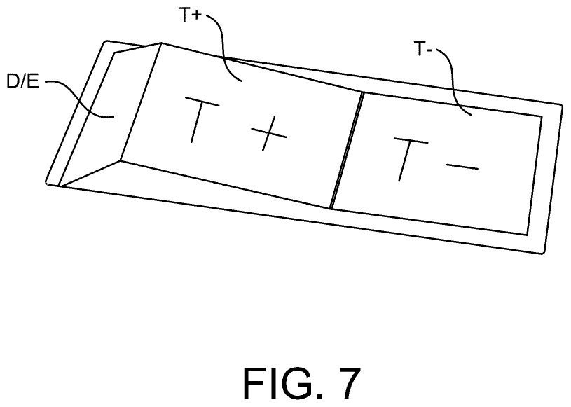

FIG. 7 is a view of a lighted display toggle switch used for temperature and time control of the warmer device in accordance to an embodiment of the present disclosure. Since the light on both toggle sides of the switch are independent and LED (light emitting diode) electronically controlled, they indicate a stepping through up or down of available times and temperatures respectively for switches/buttons D and E. For example, the temperature lit toggle switch may read 85 degrees selected (down) and 86 degrees unselected (up).

Depressing the toggling switch to 86 degrees down will then adjust the temperature to 86 degrees and the up switch will now display 87 degrees allowing a user to adjust upwardly to a predetermined maximum temperature at which point the toggle switch will start stepping down the temperature similar to how it stepped up the temperature.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A warming device comprising:
a warming container comprising a flaring closed end and an open receiving end and a throat there between configured to snugly receive a tube of mascara, wherein a wall of the funnel-shaped container is waterproof and heat insulating;
a heating element in the flaring closed end powered by a power source and a heat thereof proportional to a digital thermometer; and
a reservoir of water comprised in the flaring closed end configured for conversion to steam based on the heating element.

2. The warming device of claim 1, further comprising a control switch for the digital thermometer configured to also display a temperature of the reservoir of water.

3. The warming device of claim 1, further comprising a digital timer and a control switch for the digital timer configured to also display a time on for the power source.

4. The warming device of claim 1, further comprising a ready green light and a warming red light set in an outside wall of the warming container and configured to indicate a status of the water reservoir to produce steam.

5. The warming device of claim 1, wherein an inside wall of the throat comprises groves configured to allow a steam escape from the water reservoir.

6. The warming device of claim 1, wherein an inside wall of the throat comprises a stop boss configured to limit a drop of the mascara tube into the water reservoir.

7. The warming device of claim 1, further comprising a grating disposed in the throat and configured to limit a drop of the mascara tube into the water reservoir.

8. The warming device of of claim 1, further comprising a water fill line configured to indicate a predetermined amount of water in the funnel-shaped container.

9. The warming device of claim 1, further comprising an indicator switch configured to sequentially step through a maximum time and a minimum time for powering the heating element in seconds and minutes.

10. The warming device of claim 1, further comprising a speaker configured to sound an alarm based on a lack of water in the water reservoir.

11. The warming device of claim 1, further comprising a memory for storing a predetermined default temperature and active time for the heating element.

12. The warming device of claim 1, wherein the warming container is funnel-shaped.

13. The warming device of claim 1, wherein the warming container is trumpet-shaped.

14. The warming device of claim 1, wherein the container is gourd vase-shaped.

15. The warming device of claim 1, wherein the container is flask-shaped.

16. The warming device of claim 1, wherein the warming container is shaped like any container having a throat opened end and a flared closed end.
